(19) United States
(12) Patent Application Publication
(10) Pub. No.: US 2003/0199320 A1
(43) Pub. Date: Oct. 23, 2003

(54) Electronic prize fulfillment through intermediate devices

(75) Inventors: Binh Nguyen, Reno, NV (US); Craig Paulsen, Reno, NV (US); Steven LeMay, Reno, NV (US); Derrick Price, Las Vegas, NV (US); Richard Rowe, Incline Village, NV (US); Daryn Kiely, Henderson, NV (US)

Correspondence Address: BEYER WEAVER & THOMAS LLP, P.O. BOX 778, BERKELEY, CA, 94704-0778, US

(73) Assignee: IGT

(21) Appl. No.: 10/459,001

(22) Filed: Jun. 10, 2003

Related U.S. Application Data
(63) Continuation-in-part of application No. 09/479,754, filed on Jan. 7, 2000, now Pat. No. 6,609,978.

(51) Int. Cl. G06F 17/00

(52) U.S. Cl. 463/42

(57) ABSTRACT

A gaming system and method for facilitating electronic fulfillment of prizes is provided. Once the gaming system determines that a player is entitled to a prize for a result achieved while playing a game on the gaming machine and/or detects that a player wishes to redeem credits or a prize, the player is presented with prize fulfillment options via a player tracking device. In response to the presented prize fulfillment options, the gaming system receives prize fulfillment specifications entered by the player. These prize fulfillment specifications are communicated by the gaming system to a prize fulfillment site that is responsible for fulfilling prizes. In one embodiment, the prize fulfillment site can be remote from said property, and can be a retail entity such as an Internet retail entity. In other embodiments, the prize fulfillment site can be affiliated with the property.

### CROSS REFERENCE TO RELATED APPLICATIONS

The present application is a continuation-in-part of U.S. patent application Ser. No. 09/479,754, entitled “ELECTRONIC PRIZE FULFILLMENT FOR A GAMING SYSTEM” by Paulsen, filed on Jan. 7, 2000, which is incorporated herein by reference.

### BACKGROUND OF THE INVENTION

I. Field of the invention

The present invention relates to gaming machines such as video slot machines and video poker machines. More particularly, the present invention relates to methods and apparatus for electronic prize fulfillment using intermediate devices on gaming machines.

II. Background

Operating gaming machines in a casino or other gaming environment typically involves providing certain services that may have associated costs, among which may include prize fulfillment when players have won prizes. Prize fulfillment can be particularly problematic when non-monetary (or other substantially non-fungible) prizes, such as merchandise or services, are provided. When such non-monetary prizes are provided, often directly by the casino or other gaming establishment, the process of prize fulfillment can include a number of costs. In particular, opportunity costs to the casino or other gaming environment are associated with the prize fulfillment process. For instance, as long as a player is involved with the prize fulfillment process, the player is distracted from further game play. Furthermore, casino intervention during the prize fulfillment process, such as when completing a W2G form for larger prizes, can delay the process, thereby distracting the player from further game play and requiring the time and services of casino personnel. In addition, other costs to the casino or other gaming establishment include the cost of providing an accounting or record keeping system between the time the prize is won and the time the merchandise or service is delivered, the cost of warehousing (or otherwise making available) non-monetary prizes, the cost of actually delivering the merchandise or service, the cost of handling any defects in the merchandise, delivery of the wrong merchandise, and the like. Often, the casino or other game operator is not primarily configured for delivering the types of merchandise or services that may be offered as prizes, and the costs associated with delivering these types of merchandise or services may be more burdensome for the casino or other game establishment than they might be for other entities having businesses that are more focused on providing such items.

Nevertheless, provision of non-monetary prizes may be desirable for casinos and other gaming establishments, e.g., in situations where at least some potential players may prefer non-monetary prizes (and thus may be more attracted to those casinos or other game establishments that can offer such prizes) and/or because certain jurisdictions may restrict some or all prizes to non-monetary prizes. Accordingly, it would be useful to provide a system that facilitates providing non-monetary prizes, e.g. by reducing some or all of the cost or burdens associated with non-monetary prizes in previous systems. It also would be useful to provide a system which facilitates shifting some or all of the costs associated with non-monetary prizes to an entity other than the casino or other game establishment, such that the steps or services provided for non-monetary prize fulfillment can be performed by entities that are more equipped to provide such steps or services as an ordinary part of their business.

Although non-monetary prizes may be preferred by at least some players, it is believed that players, in general, wish to have a wide, and preferably changing, variety of non-monetary prizes available and that if the players perceive that they are offered substantially the same non-monetary prizes over an extended time period, their desire to continue playing at a casino or other gaming establishment for an extended period of time or return to a casino or other gaming establishment at a later time may be reduced. However, casinos or other gaming establishments have generally found it infeasible to maintain a sufficiently large and/or time-varying inventory of merchandise or other non-monetary prizes to maintain player interest. Accordingly, it would be desirable to provide a system for non-monetary prize fulfillment that can offer a desirable degree of prize variability while reducing the costs to casinos or other gaming establishments. It would also be desirable to reduce the amount of time that a player is involved in the prize fulfillment process, thereby allowing the player to continue game play sooner and reducing the amount of involvement by casino personnel. In addition, it would be desirable to provide such a system for non-monetary prize fulfillment that can be used with legacy machines, which may otherwise lose value to the casino or other gaming establishment or become obsolete with a shift to non-monetary prize fulfillment.

### SUMMARY OF THE INVENTION

The techniques of the present invention address the above need by providing methods, code and apparatus that use intermediate devices to facilitate electronic prize fulfillment. The invention accomplishes this by using the intermediate devices to communicate prize fulfillment requests from a gaming machine to a prize fulfillment site, which can be a separate entity from the casino or gaming establishment hosting the gaming machine and can be configured to provide goods and/or services in response to electronically-delivered requests or orders. Using intermediate devices for prize fulfillment in this manner allows both new and legacy machines to provide non-monetary prize fulfillment to players.

One aspect of this invention pertains to a method of fulfilling prizes won during game play on a gaming machine. This method may be characterized by the following sequence of operations (typically implemented on a computing device, but not necessarily in the order listed): (a) determining that a player is entitled to a prize for a result achieved while playing a game on the gaming machine; (b) presenting prize fulfillment options to the player via a player tracking device; (c) receiving prize fulfillment specifications entered by the player in response to the presented prize fulfillment options; and (d) communicating the player's prize fulfillment specifications to a prize fulfillment site that is responsible for fulfilling prizes and is remote from said property.

Another aspect of this invention pertains to a gaming machine apparatus. Such apparatus may be characterized by the following features: (a) a master gaming controller configured to control the outcomes of games played on the gaming machine, wherein prizes may be awarded for the outcomes; (b)a player tracking device comprising (i) a video display screen; (ii) logic for providing a prize fulfillment player interface through the display screen; and (iii) logic for providing a prize selection player interface through the display screen; and (c) a network interface configured to communicate prize selection and prize fulfillment to one, or remote prize fulfillment sites that are responsible for fulfilling the prizes.

According to another aspect, a gaming machine apparatus can be characterized by the following features: (a) a player tracking device comprising (i) a video display screen; (ii) logic for providing a prize fulfillment player interface through the display screen; and (iii) logic for providing a prize selection player interface through the display screen; and (b) a network interface configured to communicate prize selection and prize fulfillment to one or remote prize fulfillment sites that are responsible for fulfilling the prizes. Accordingly a player can redeem a prize at a gaming machine apparatus, without having to play a game immediately preceding such redemption.

Yet another aspect of the invention pertains to computer program products including machine-readable media on which are stored program instructions for implementing a portion of or an entire method as described above. Any of the methods can be provided on such computer readable media. In addition, the invention pertains to various combinations of data generated and/or used as described herein.

These and other features and advantages of the present invention will be described in more detail below with reference to the associated figures.

### BRIEF DESCRIPTION OF THE DRAWINGS

FIG. 1 is a block diagram depicting components of a prize fulfillment arrangement for use by a gaming system according to an embodiment of the present invention;

FIG. 2 is a process flow diagram depicting a prize fulfillment process according to one embodiment of the present invention;

FIG. 3 is a process flow diagram depicting a prize fulfillment process according to another embodiment of the present invention; and

FIG. 4 is a process flow diagram depicting a prize fulfillment process according to yet another embodiment of the present invention.

FIG. 5 is a perspective drawing of a video gaming machine.

FIG. 6 is a diagrammatical representation of a player tracking unit interface.

FIG. 7 is a diagrammatical representation of a prize redemption player interface.

FIG. 8 is a diagrammatical representation of a prize selection player interface.

FIG. 9 is a diagrammatical representation of a prize fulfillment player interface.

### DETAILED DESCRIPTION OF INVENTION

As described in the Background section above, it would be desirable to provide a cost-efficient way for casinos and other gaming establishments to provide non-monetary prizes for winnings on gaming machines. Furthermore, it would be desirable provide such a system for use with legacy machines, such that the legacy machines can also provide non-monetary prizes. Accordingly, the techniques of the present invention provide methods, apparatus, and code that use intermediate devices to facilitate non-monetary prize fulfillment. In particular, various embodiments of the present invention use the intermediate devices to electronically communicate prize fulfillment requests from a gaming machine to a remote or affiliated prize fulfillment site, which can provide goods and/or services to a player in response to the requests or orders. Furthermore, the intermediate devices can be included in legacy machines, thereby allowing these legacy machines to participate in non-monetary prize offerings.

As used herein, prize fulfillment refers to the process of arranging for delivery of a specific prize to a winning player. Generally, prize fulfillment can be considered a subset of prize redemption, which refers to the exchange of one form of value for another form of value. For instance, a player can exchange accumulated credits on a gaming machine for a non-monetary prize or currency. This exchange can include operations such as verifying the amount of credits with an accounting database, determining the value of a selected non-monetary prize, subtracting the number of credits equal to the value of the selected prize from the player's account, arranging for delivery of the prize to the player, and delivering the prize to the player. Prize fulfillment can include some of these operations, depending on the application. For instance, prize fulfillment may focus on operations relating to the delivery of the prize to the player. Accordingly, in some embodiments, prize fulfillment can include only arranging for delivery of the prize and delivering the prize. However, in some embodiments, prize fulfillment may also include additional operations such as determining the value of the prize, receiving money or other currency amounting to the value of the prize in some form from a casino, gaming establishment, player, or the like, arranging delivery, and delivering the prize. Similarly, prize fulfillment in other embodiments can have various combinations of operations, depending on the particular application.

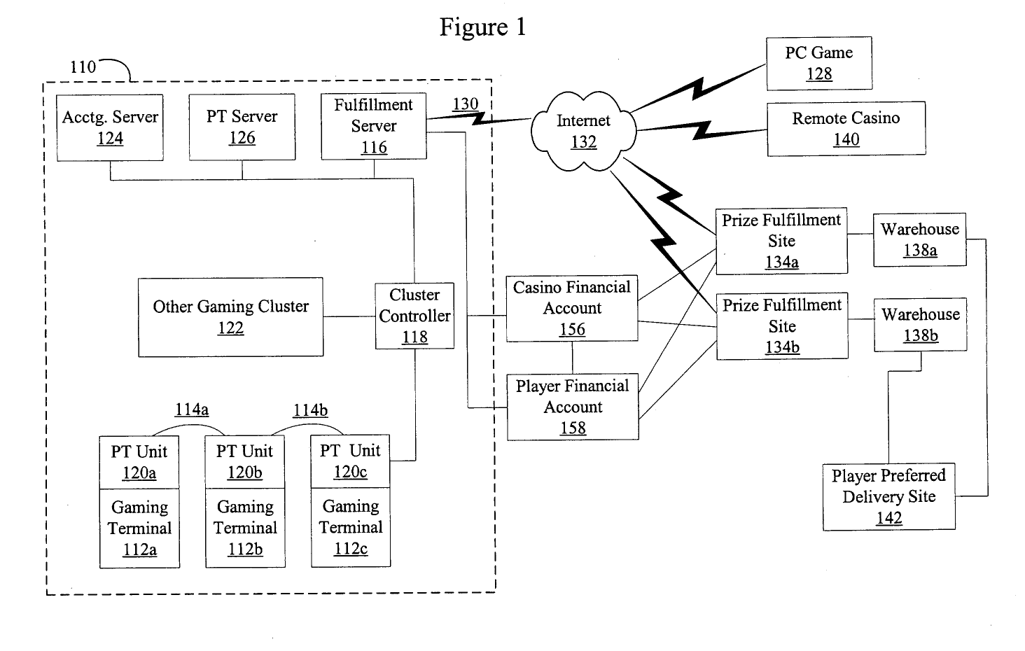

With reference to FIG. 1, shown is one embodiment of a gaming system that can be used to provide electronic, non-monetary prize fulfillment. As depicted in FIG. 1, a casino or other gaming establishment 110 can provide a plurality of gaming machine terminals 112a, 112b, and 112c, which are equipped to present games of chance to players. These gaming machine terminals 112a, 112b, and 112c can each include an intermediate device, such as a player tracking unit 120a, 120b, and 120c, or the like, that can be used to communicate between the gaming machine terminal and other components of the network, such as accounting server 124, player tracking server 126, fulfillment server 116, and the like. For instance, player tracking units 120a, 120b, and 120c, can communicate via one or more player tracking devices included in the player tracking unit with fulfillment server 116 via daisy chain couplings 114a and 114b and cluster controller 118, or through any other intermediate computers that may be included in the gaming system. In particular, player tracking unit 120b can communicate with fulfillment server 116 by communicating over daisy chain coupling 114b and via cluster controller 118. Furthermore, cluster controller 118 can also be coupled to one or more other gaming clusters 122. Various components of the gaming system shown can be coupled by a fiberoptic network, cable network, or the like.

Player tracking units 120a, 120b, and 120c typically allow players to participate in loyalty point programs, such as player tracking programs, offered by various casinos. Generally, loyalty point programs provide rewards to players in proportion to the player's level of patronage (e.g., to the player's playing frequency and/or total amount of game plays at a given casino). Loyalty point rewards may be free meals, free lodging and/or free entertainment. These rewards may help to sustain a game player's interest in additional game play during a visit to a gaming establishment and may entice a player to visit a gaming establishment to partake in various gaming activities.

As described above, player tracking units 120a, 120b, and 120c can include one or more player tracking devices. These player tracking devices can be output devices such as LCD screens, other game displays or outputs, and/or input devices such as touch screens, one or more keys or keyboards, card readers such as player card readers, wager inputs such as a coin, ticket, token or bill acceptors, one or more monetary prize output devices such as a coin output tray, cashless ticket printers that are compatible with a system such as EZ Pay™, or the like. Typically, when a game player wants to play a game on a gaming machine 112a, 112b, or 112c, and participate in a player tracking program, a game player inserts a player tracking card, such as a magnetic striped card, into a player tracking device such as a card reader. The card reader may receive certain player identification information from the card, such as a player's name, address, and player tracking account number, which it may relay to a player tracking server 126 that typically stores player tracking account records including the number of player tracking credits previously accumulated by a player.

While the card is inserted during game play on the gaming machine 112a, 112b, or 112c, the player tracking unit 120a, 120b, or 120c may poll the gaming machine 112a, 112b, or 112c for game play information such as how much money the player has wagered on each game, the time when each game was initiated and the location of the gaming machine 112a, 112b, or 112c. The game play information can be sent by the player tracking unit 120a, 120b, or 120c to the player tracking server 126 and may be used to generate player tracking points and add the points to a player tracking account identified by the player tracking card. The player tracking points generated by the player tracking server 126 can be stored in a memory of some type on the player tracking server 126 and/or the player tracking card. These points can be used to earn “comps.” Additionally, in some embodiments, these points can be added as credits that the player can redeem for prizes or currency. For instance, the points can be added to an account directly as credits or the points can be converted to credits, depending on the application.

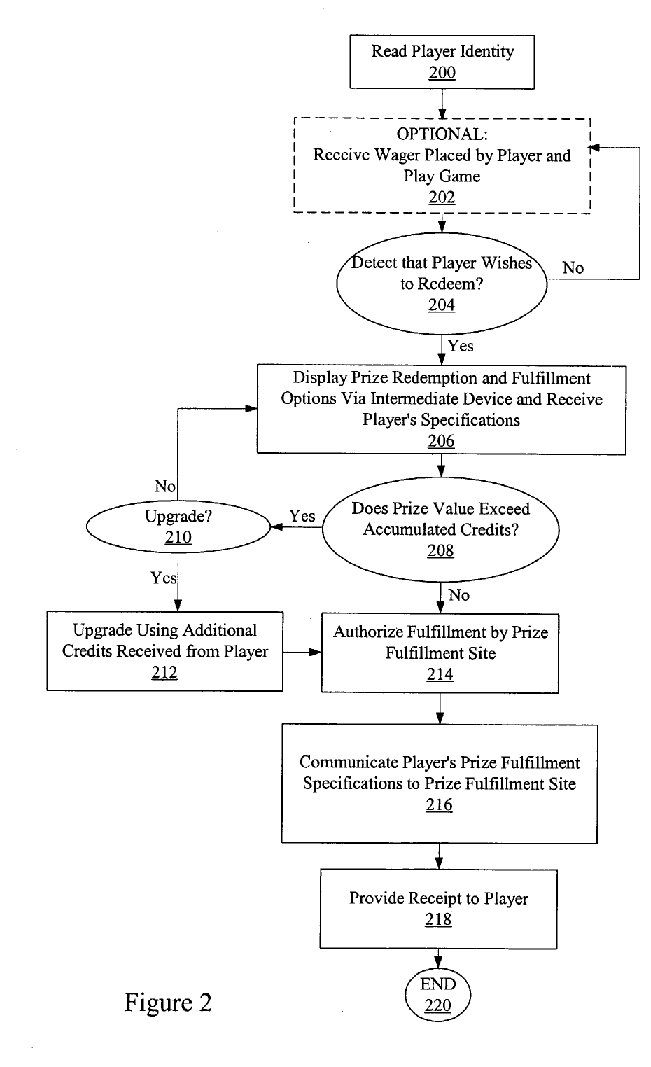

In addition to providing traditional programs such as loyalty point programs, the present embodiment allows player tracking units 120a, 120b, and 120c to provide communications between gaming machines 112a, 112b, and 112c and prize fulfillment sites 134a and 134b, in order to facilitate non-monetary prize offerings to players. As described in more detail below with regard to FIGS. 2-4, player tracking units 120a, 120b, and 120c can communicate prize fulfillment requests from players interacting with gaming machines 112a, 112b, and 112c to remote prize fulfillment sites 134a and 134b, which can provide goods and/or services to the player in response to the electronically-delivered requests or orders. The prize fulfillment sites 134 can be retail entities such as Internet retail entities that are not part of or controlled by the casino. However, these prize fulfillment sites 134 can also be part of or affiliated with the casino in some applications. In some embodiments, available prizes can be displayed to a player through player tracking devices housed by player tracking units 120a, 120b, and 120c. The player can select a prize via a player tracking device, and can enter other information, as needed, such as delivery information. Furthermore, the player can complete a W2G for larger prizes, without intervention from casino or other gaming personnel.

Typically, gaming machine terminals 112 are controlled by a master gaming controller such as a computer, other microprocessor-based circuitry, or the like, programmed to present one or more games of chance. These games of chance can include a variety of games such as slot machine games or simulated slot machine games, simulated card games, keno games, arcade games, and the like. In some embodiments, gaming machines 112 can provide two or more related games that are selected by a player or that are configured by the casino or other game operator. These related games can include one or more main games and one or more bonus games, which can be provided either or both on the main portion of the gaming machine 112 or on a device included in the player tracking unit 120, such as a display screen. These main games and bonus games may include various levels or types of prizes, including various numbers of credits and/or non-monetary prizes. The credits can be converted to either currency or non-monetary prizes. The non-monetary prizes can either be redeemed “as-is” or converted to other prizes or currency. The gaming system shown in the present embodiment can be used to facilitate prize fulfillment arising from main games, bonus games, and/or any other games that may be provided on gaming machines 112. Although a master gaming controller is included in gaming machines of the present embodiment, it should be recognized that gaming machine terminals 112 can act as clients in some applications and an external computer, server, or the like, can present one or more games of chance to the gaming machine terminals 112. In these applications, gaming machine terminals 112 may not include master gaming controllers.

In the present embodiment, fulfillment server 116 is provided with a connection 130 to the Internet 132, an Intranet system, or other electronic communication system, which can provide access to one or more prize fulfillment sites 134a and 134b, which are responsible for fulfilling prizes. These prize fulfillment sites 134a and 134b can be Internet-based or Internet-enabled retail entities that typically provide goods and/or services to customers outside of the gaming context, and are remote to the casino 110 or other gaming establishment. In other embodiments, one or more of the prize fulfillment sites 134 can be affiliated with the casino or gaming establishment, such as a casino merchandise store, a theater ticket booth, restaurant, or the like, and may or may not be remote. For Internet-based prize fulfillment sites 134, the prize fulfillment information provided by a player via player tracking device, or by player tracking server 126 from player tracking information, is delivered to an applicable prize fulfillment site 134 over the Internet. Other entities can also be connected to prize fulfillment sites 134 through Internet 132 such as a personal computer 128 that can be used by individuals to play games from their homes or other sites outside of a traditional gaming environment, a remote casino 140, and the like.

As used herein, the term Internet should be understood as including not only those communications using an Internet Protocol which are conveyed (typically long distances) over e.g. an Internet backbone, but, as well, other communications which use Internet protocols, Hypertext Transfer Protocols (HTTP) and the like, such as Internet-style communications that can be conveyed over local area networks (LANs) or similar local systems, including so-called Intranet communications and systems.

Prize fulfillment sites 134 can be affiliated with warehouses 138a and 138b, respectively, that store goods or provide services. Goods can be delivered to a player's preferred delivery site 142, as specified by the player through player tracking unit 120 either manually or via a player tracking card, or the like. Services can either be provided at the warehouse 138 or at other locations for which vouchers for services can be distributed via player tracking units 120, or the like, to a player's preferred delivery site 142.

In the present embodiment, fulfillment server 116 can also communicate with casino financial account 156, player financial account 158, and/or any other financial accounts. These accounts can include bank accounts, credit accounts, and the like. These accounts, in turn, can communicate with prize fulfillment sites 134. As described in more detail below in accordance with various exemplary embodiments, fulfillment server 116 can authorize transfers of funds or other forms of currency to prize fulfillment sites 134 in conjunction with prize fulfillment. In one embodiment, accounting transactions between the casino and the prize fulfillment entity are settled electronically such as by the casino transmitting an authorization to debit the casino financial account 156, and the prize fulfillment site 134 transmitting a demand or request for funds from the casino financial account 156. Accounting server 124 can keep records of such transactions and accounts.

With reference to FIG. 2, shown is a flow chart depicting an exemplary embodiment of a prize redemption and fulfillment process. At 200, player tracking unit 120 reads or obtains player identification information such as a player name, a player identification number, or the like. Additional information such as a preselected prize, a preferred delivery site, delivery information, and the like, can be included in the player identification information or in a database accessible using player identification information, such as a player identification number. Typically, the player identification information can be obtained from a player-card reader, although it is also possible to provide for biometric identification, e.g. as described in U.S. patent application Ser. No. 09/491,899, entitled “GAMING TERMINAL AND SYSTEM WITH BIOMETRIC IDENTIFICATION,” by Wells et al., filed on Sep. 13, 1999, incorporated herein by reference, or to prompt the player for manual input of player information, e.g. via a touch screen, keyboard, or the like. Once player identification information is obtained, the information can be transmitted to fulfillment server 116, for use as described below.

Next, at 202 the player can place a wager and play a round of a game, such as a spin of either mechanical or electronic slot machine reels, a hand of simulated cards, or the like. A determination is made by gaming terminal 112, fulfillment server 116, or some other central computer, as to whether the outcome of the game is associated with the winning of a prize. This outcome can be displayed on a screen of the player tracking unit 120 and/or generally on the gaming machine 112. For instance, a specific prize won or a number of credits won can be displayed on player tracking unit 120 or gaming machine 112. In some embodiments, if a player has preselected a prize, the prize or other notification can be displayed when the player has won the preselected prize or has accrued enough points for the prize, and is thereby entitled to redeem the prize. If a prize is not won, the process allows additional wagering and play if desired.

In some embodiments, game play and receipt of a wager at 202 can be omitted, such as when a player wishes to redeem accumulated credits from previous game play at a later time. In these embodiments, a player can use a player tracking unit 120 on a gaming machine such as a slot machine, video poker machine, or the like, to redeem credits without having to participate in additional game play at the time the player wishes to redeem credits. Accordingly, a player can accumulate credits during one or more gaming sessions and return later to redeem these credits for a prize. One benefit of allowing players to redeem credits at gaming machines in this manner is that each of the gaming machines can act as kiosks, thereby reducing the need for casinos or other gaming establishments to provide separate kiosks for prize redemption.

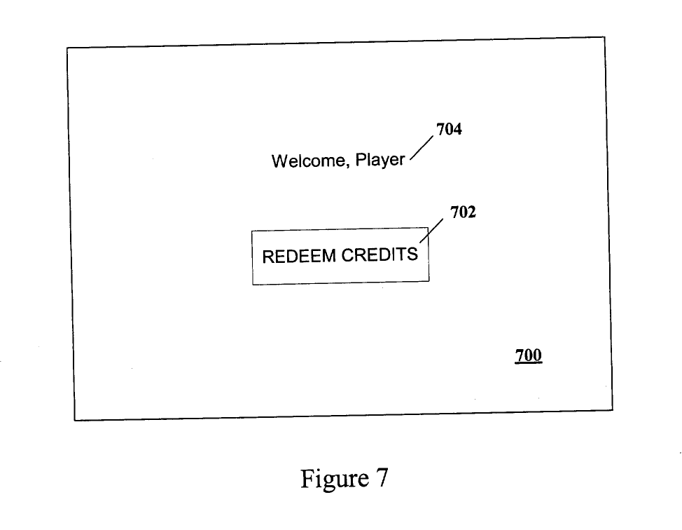

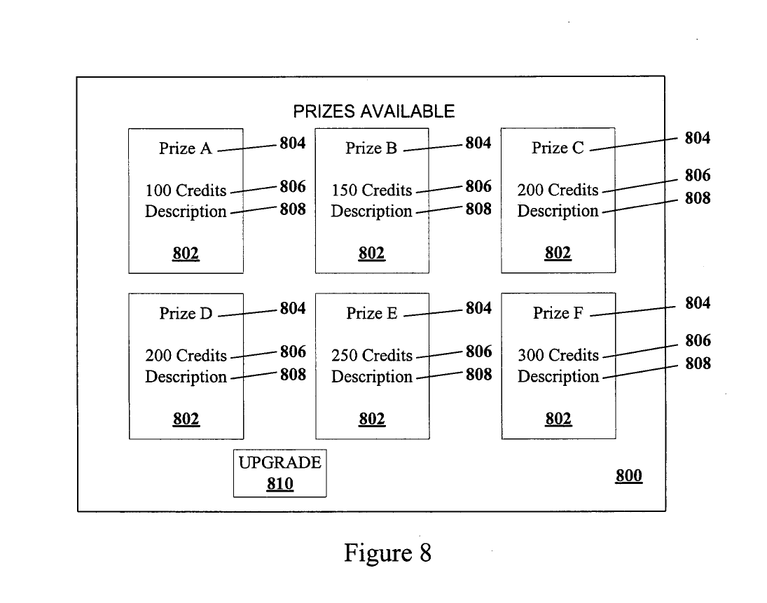

In the present embodiment, if a specific prize has been won or if credits have been accumulated by a player, player tracking unit 120 can provide an option for the player to redeem the prize and/or credits. For instance, with reference to FIG. 7, a touch screen 700 on player tracking unit 120 can provide one or more buttons 702 that can be selected when a player wishes to redeem a prize and/or credits. As shown, a general redemption button 702 can be displayed once any prizes or credits have been accumulated. Alternatively, a plurality of buttons corresponding to different prizes can be selectable, as shown in FIG. 8 and described in more detail below, which allow redemption of specific prizes. These prizes can be preselected prizes that are redeemable by the player, and were preselected either by the player or by the gaming system. In some embodiments, the prize redemption player interface 700 shown in FIG. 7 can be omitted, such as when a prize selection player interface 800, as shown in FIG. 8, allows initiation of the redemption process by selection of a specific prize. Other features may also be included on touch screen 700 such as a greeting 704, graphics, and the like. Although a touch screen is shown, other configurations of display screens and inputs can be used such as a display screen with a keypad or other selection buttons that are separate from the display screen.

At 204, if a player does not wish to redeem a prize or credits, then game play can continue at 202 or the session can end, depending on the application. However, if the player does wish to redeem a prize or credits, then at 206, prize redemption and fulfillment options can be displayed by the player tracking unit 120. With reference to FIG. 8, the prize redemption options can be displayed on a prize selection screen 800 and can include a list, or other representation, of available prizes 804. Additional information about the prizes can also be included such as the value of the prize 806, a description of the prize 808, and the like. As shown, prizes can be selected via touch screen 800 by selecting buttons 802. Although a touch screen is shown, other configurations of display screens and inputs can be used such as a display screen with a keypad or other selection buttons that are separate from the display screen. Once the selection of a prize is received by player tracking unit 120, then a prize fulfillment interface can be displayed to the player.

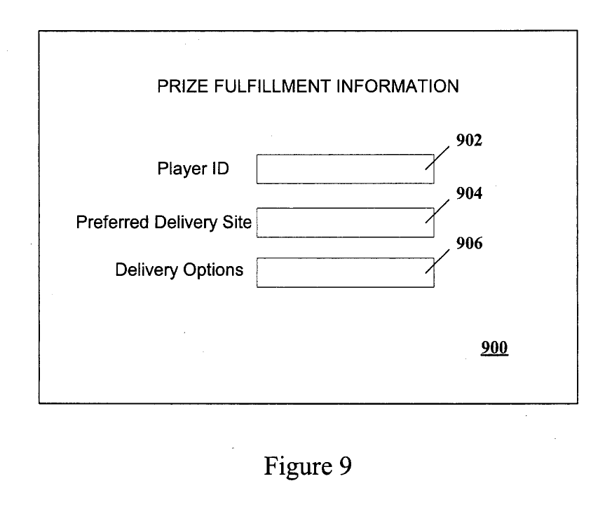

With reference to FIG. 9, the prize fulfillment options can be displayed on a prize fulfillment player interface 900. This interface 900 can include fields that can be used to specify fulfillment information, and can also include information such as instructions, disclaimers, policies, and the like (not shown). In the present embodiment, interface 900 includes a field 902 to specify player identification information, field 904 to specify a preferred delivery site 142 (FIG. 1) for the prize, and field 904 to specify one or more delivery options, such as a shipping method. For instance, the preferred delivery site 142 can be the address to which the player wishes the prize to be delivered (specified either at the time that the prize is won or at a previous time, with the information being stored for later use), such as a player's home or business address, a player's hotel room, a third party address specified by the player, and the like. It is also possible to base the delivery site on other information such as credit card address information, player card address information, hotel registration information and the like. Furthermore, delivery option(s) 904 may include a list of available shipping methods such as ground, post, second day, overnight courier, mail, parcel delivery service, courier service, delivery by employees of the warehouse 138, prize fulfillment site 134 and/or casino 110, and the like. Furthermore, the delivery option(s) can include an option to upgrade from the default standard shipping method by authorizing an additional delivery fee, which can be deducted from the player's credits, charged to a credit card or a player financial account 158, or the like. Any of the fields described can be pull down menus with selectable entries, fill-in fields, or the like. In some embodiments, interface 900 can be omitted if the information is already specified in the player's player tracking account, or if the player has otherwise previously specified the information.

In such cases where the fulfillment information is already specified in the player's player tracking account, then quick redemption of a prize or credits can be implemented to allow a player to redeem a prize without having to re-enter this information. For instance, a player can select a prize as described, for example, with respect to FIG. 8. Once this prize is selected, the player tracking unit can display the player's fulfillment information, including a preferred delivery site 142 (FIG. 1), and the player can verify this information by selecting a button, providing a voice command, or the like. This information can then be sent to prize fulfillment site 134 for delivery of the prize to the player. Alternatively, if a prize has been preselected, such as by the player or the gaming system, the player can verify a preselected prize. Once the player confirms that he or she would like to redeem this preselected prize, the player tracking unit can display the player's fulfillment information, including a preferred delivery site 142, and the player can verify this information by selecting a button, providing a voice command, or the like. This information can then be sent to prize fulfillment site 134 for delivery of the prize to the player. In other embodiments, once a player selects a prize or verifies a preselected prize, such as by selecting a button, providing a voice command, or the like, some or all of the player's fulfillment information can be immediately sent to prize fulfillment site 134 for delivery of the prize to the player. One example of a system that can be used to implement the quick redemption system is described in U.S. Pat. No. 5,960,411, entitled “Method and system for placing a purchase order via a communications network,” by Hartman et al., filed on Sep. 12, 1997.

In the present embodiment, if a selected prize has a value that exceeds the player's accumulated credits, then at 208 an option to upgrade can be provided to the player at 210. If the player chooses to upgrade, by selecting button 810 as shown in FIG. 8, or by selecting a button on a similar interface, or otherwise providing an appropriate input, in response to an indication by the gaming machine that the selected prize exceeds the accumulated credits, then at 212, credits can be received from the player to upgrade to the prize. More particularly, the player can insert currency, debit an account, apply a charge to a credit account, or the like, in order to add to his or her accumulated credits. For instance, currency can include cash, coins, an EZ Pay™ ticket, a smart card, or the like. Furthermore, the player can debit an account or apply a charge to an account and add the currency thereby obtained to the accumulated credits. In some embodiments, selection of the upgrade button 810 can prompt the gaming machine to display prizes having higher values, thereby allowing the player to determine how many additional credits are needed to redeem a displayed prize. Furthermore, displaying these prizes can provide the player with an incentive to engage in additional game play in order to earn a displayed prize, thereby adding to the excitement of the game. However, if the player does not choose to upgrade at 210, then prize redemption and fulfillment options can be displayed again to the player at 204. In other embodiments, if the player does not choose to upgrade at 210, then game play can continue at 202 or game play can end at 220, depending on the desired application.

Once the gaming machine has determined that the player is entitled to a chosen prize by having the requisite number of accumulated credits, then at 214, the fulfillment server 116 can authorize fulfillment of the prize by a fulfillment site 134. In particular, fulfillment server 116 can prepare to transfer funds or other currency from casino financial account 156 to a prize fulfillment site 134. In some embodiments, if the player has authorized a debit or credit of a personal financial account 158, then funds or other currency can be transferred from the player's financial account 158 to casino financial account 156, in exchange for the accumulated credits needed to redeem the selected prize. In other embodiments, the player's financial account 158 may provide funds or other currency directly to a prize fulfillment site 134.

Next, at 216, the player's prize fulfillment specifications, or any portion of them, can be communicated to a prize fulfillment site 134, along with an authorization to transfer funds or other currency from the casino financial account 156, the player financial account 158, and the like and combinations thereof. Alternatively, the authorization can be to charge a casino or other account, which will be billed by the prize fulfillment site 134 at a later time. The communications between fulfillment server 116, prize fulfillment site 134, casino financial account 156, player financial account 158, and any other devices can be performed via electronic communication. Electronic communication may be in one form of a Internet protocol message such as a web site request message, an Internet e-mail protocol message, or other types of electronic message formats such as local area network messages, wide area network messages, and the like. In other embodiments, other, non-Internet communication systems can be used such as a telephone communication system, satellite communication system, local area network or wide area network communication systems, and the like. It is possible to provide configurations of the present invention in which some or all prizes are fulfilled by an electronic fulfillment process but in which the fulfillment process is performed or controlled substantially by the casino or other game operator.

An electronic message sent from fulfillment server 116 to prize fulfillment site 134 can be encoded or otherwise secured, and can include information such as indicators of the size or type of prize to be fulfilled and delivery information. Some or all of the prize fulfillment information can be included in the message. It is possible to include additional information in the electronic communication such as information regarding the identity or preferences of the player, previous prize or gaming history of the player, and the like, depending on the application. The information sent from fulfillment server 116 to prize fulfillment site 134 can be provided in a single message or in two or more different messages. Some or all of the information may come directly from fulfillment server 116 or from another source such as from the gaming terminal 112.

Although the present embodiment includes communicating the prize fulfillment specifications and fund authorization to the prize fulfillment site 134 during a transaction with the player, in other embodiments, the prize fulfillment specifications and fund authorization can be communicated to the prize fulfillment site 134 periodically, according to a schedule. In particular, multiple prize fulfillment specifications and funds authorizations from various players and/or gaming transactions can be communicated together at a later time, thereby allowing the fulfillment server 116 to avoid keeping a full-time connection to the prize fulfillment site 134, which may be costly. Furthermore, when fulfillment server 116 communicates these prize fulfillment specifications and funds authorizations to a prize fulfillment site 134, prize fulfillment server 134 can also obtain updated information from the prize fulfillment site 134 about prize offerings, prize value, and the like. In this manner, prize fulfillment site 134 can provide updated prize information to player tracking devices 120 without having to establish a real-time connection to prize fulfillment sites 134.

Once the player's prize fulfillment specifications are communicated to prize fulfillment site 134 and an authorization to transfer funds or other currency to prize fulfillment site 134 is made, then at 218, a receipt can be provided to the player. The receipt can include information about the prize fulfillment specifications, the time, the date, and the like, and can be printed by a ticket printer such as an EZ Pay™ ticket printer, or the like. This receipt can be used by the player to track the prize or otherwise follow-up with the casino or prize fulfillment site during prize fulfillment. After the receipt is printed, then the process ends at 220. Alternatively, if multiple gaming transactions are communicated from fulfillment server 116 to prize fulfillment sites 134 at a later time, then a receipt can be provided once all of the necessary information is provided by the player to the fulfillment server 116.

Once a prize fulfillment site 134 receives an electronic message from the fulfillment server 116 to fulfill a prize, the prize fulfillment site 134 makes arrangements to deliver the merchandise to the specified player, e.g. from a warehouse 138 associated with or otherwise serving the prize fulfillment site 134. For example, the prize fulfillment site 134 may deliver an electronic message to the warehouse 138 requesting or ordering the warehouse 138 to deliver a particular item or items to the preferred address specified by the player as prize fulfillment information, stored as player tracking information, or the like.

In some embodiments, some or all non-monetary prizes may involve delivery of services rather than merchandise. Some examples of service-based prizes include tickets, or other indicator of admission, to theater, show, or other entertainment events, sports events, personal services such as spa services, airline or other travel services, hotel or other lodging services, restaurant services, and the like. For the award of services, prize fulfillment may involve delivery of one or more tickets, coupons, vouchers or other entitlement papers or tokens. These items can be either delivered by the mechanisms described above, picked up by the player at a designated location, or printed out at the gaming machine. Furthermore, in some embodiments, the fulfillment server can send a communication to the service provider that notifies the service provider of the award.

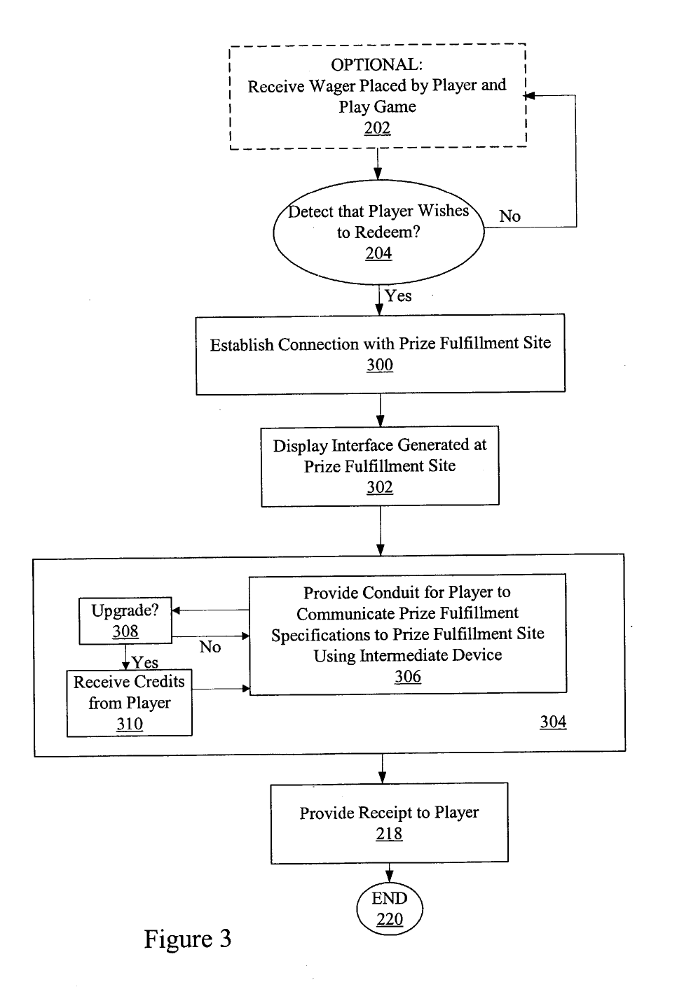

With reference to FIG. 3, shown is a flow diagram depicting a prize fulfillment process according to another embodiment of the present invention. In some situations, players may be reluctant or unwilling to provide identity, address, or other personal information to a casino or other game operator. Accordingly, the present embodiment can be implemented without requiring the player to provide name, address, or other personal information to the casino for storage in a player tracking account or other database.

At 202, as described above in the discussion of FIG. 2, the player can place a wager and play a round of a game, such as a spin of either mechanical or electronic slot machine reels, a hand of simulated cards, or the like. A determination is made by gaming terminal 112, fulfillment server 116, or some other central computer, as to whether the outcome of the game is associated with the winning of a prize. This outcome can be displayed on a screen of the player tracking unit 120 and/or generally on the gaming machine 112. For instance, a specific prize won or a number of credits won can be displayed on player tracking unit 120 or gaming machine 112. More specifically, in some embodiments, if a player has preselected a prize, the prize or other notification can be displayed when the player has earned the preselected prize, and is thereby entitled to redeem the prize. If a prize is not won, the process allows additional wagering and play if desired. As described above in the discussion of FIG. 2, game play and receipt of a wager at 202 can be omitted in some embodiments, such as when a player wishes to redeem accumulated credits from previous game play at a later time.

In the present embodiment, if a specific prize has been won or if credits have been accumulated by a player, player tracking unit 120 can provide an option for the player to redeem the prize and/or credits. For instance, with reference to FIG. 7, a touch screen 700 on player tracking unit 120 can provide one or more buttons 702 that can be selected when a player wishes to redeem a prize and/or credits. As shown, a general redemption button 702 can be displayed once any prizes or credits have been accumulated. Although a touch screen is shown, other configurations of display screens and inputs can be used such as a display screen with a keypad or other selection buttons that are separate from the display screen. If the player does not wish to redeem credits or prizes at 204, then game play can continue at 202.

Once an indication that the player wishes to redeem credits or prizes is detected by player tracking unit 120, such as when the player selects a redeem button 702 (FIG. 7), then at 300, a connection can be established between the player tracking unit 120 and a fulfillment site 134. In particular, player tracking unit 120 can communicate with one or more prize fulfillment sites via the Internet or other electronic communication medium (a direct linkage between player tracking unit 120 and Internet 132 is not shown in FIG. 1, but can be included in the present embodiment). In other embodiments, player tracking unit 120 can communicate with one or more prize fulfillment sites via the fulfillment server 116 and/or cluster controller 118, as depicted in FIG. 1. Once the connection is established with prize fulfillment site 134, then at 302, the player tracking unit 120 displays a website, webpage, or other interface presented by the prize fulfillment site 134. Furthermore, fulfillment server 116 can authorize payment to prize fulfillment site 134 from casino financial account 156 in an amount that is equivalent to the prize or credits that the player wishes to redeem. In other embodiments, fulfillment server 116 can authorize prize fulfillment site 134 to fulfill prizes up to a certain value and to bill the casino. Similarly, other arrangements can be made between the casino and prize fulfillment site 134 within the scope of the present invention.

Next, at 306, player tracking unit 120 provides a conduit for the player to communicate prize fulfillment specifications to the prize fulfillment site 134. For instance, based on the number of accumulated credits or a preselected prize that has been won, particular prizes redeemable to the player can be displayed. Next, the player can select or confirm a selection of one or more of the displayed prizes, provide a preferred delivery site, and specify a type delivery, and the like. For example, the player can provide delivery information such as an address, hotel room number, or the like, via player tracking unit 120 by using a touchscreen, buttons, or the like. In this manner, fulfillment information such as delivery information can reach the prize fulfillment site 134 without being provided to or being stored at the casino.

Although the present embodiment can be implemented in configurations in which the prizes won are chosen without substantial user input or choice, the present embodiment can also be implemented in configurations in which a player is provided with redemption options for selecting prizes, and the like. For instance, a player can be given an opportunity to select among a plurality of prizes and/or to select features or options of a prize (such as color, size, flavor and the like). In one embodiment, the particular items from which the player may select, and/or the manner in which the selection is displayed to the user is substantially controlled by the prize fulfillment site 134. As described above, the user can be presented with one or more web pages transmitted from the fulfillment site 134 over the Internet 132 for display on a display device of player tracking unit 120. For example, the prize fulfillment site 134 may select or formulate a web page to display a plurality of prize options through the player tracking unit 120. By way of illustration, if a player has won a t-shirt prize, the prize fulfillment site 134 may download a web page displaying a plurality of different t-shirts from which the player may select and the prize fulfillment site 134 may offer the player the option to choose among various t-shirt sizes, colors, styles, and the like. The downloaded web page may, in some instances, include the name or other identification and/or advertising information of or for the company performing the fulfillment services.

According to various embodiments, the player's choices are limited to prizes that generally correspond to the value of the prize won or credits earned, and these choices are downloaded and displayed by the prize fulfillment site 134. However, it is also possible to provide the player with an option to upgrade or otherwise change a prize that has been won, as shown at 308. For example, if the player has won a t-shirt, the player may be presented with an option to upgrade to a jacket or sweatshirt. In one embodiment, this is achieved by allowing the user to pay for the additional cost or value of the upgraded prize, e.g. by charging the player's credit card or player financial account 158. At 310, this charge can be applied directly by prize fulfillment site 134 to the player or player financial account 158 without involvement by the casino. Alternatively, the player can insert currency or otherwise add credits to the gaming machine. Upon receipt of these additional credits, fulfillment server 116 can authorize prize fulfillment site 134 to fulfill an order for a higher-valued prize. Once the fulfillment information and any other necessary information is provided to the prize fulfillment site, then at 306, a receipt can be issued to the player. For instance, a ticket printer can dispense a printout of the fulfillment information displayed on the player tracking unit 120 once the transaction is complete. The prize fulfillment site 134 then delivers the one or more prizes to the player according to any prize fulfillment information provided by the player to the prize fulfillment site. As described with regard to FIG. 2, it is also possible to send multiple gaming transactions to a prize fulfillment site at a later time. In these embodiments, a receipt can be provided to the player once the fulfillment information is provided to the fulfillment server 116.

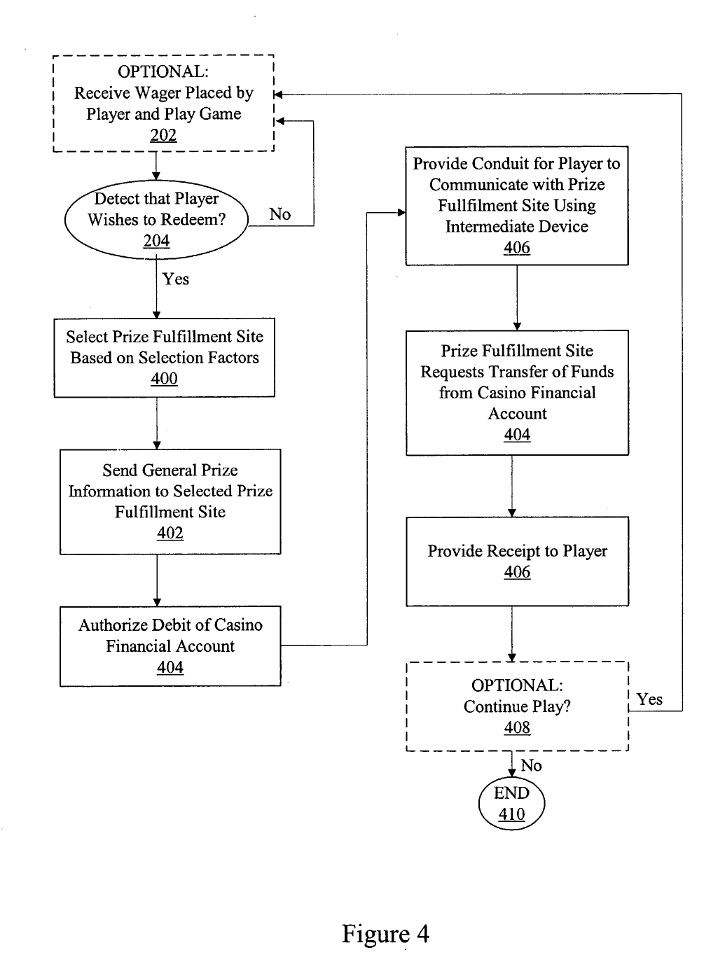

With reference to FIG. 4, shown is a flow diagram depicting another embodiment of a prize fulfillment process. As described in the Background section above, it is desirable to provide a variety of merchandise items and/or services as prizes. Although it is possible to use a single fulfillment site 134 or company to provide a wide variety of prizes, it may be preferable to use two or more different fulfillment companies or entities 134 to provide a desired amount of variety. Accordingly, in the present embodiment, two or more prize fulfillment sites are available to provide prizes to players.

The present embodiment is similar to the embodiment described in conjunction with FIG. 2 except that two or more prize fulfillment sites are available. At 202, the player can place a wager and play a round of a game, as described in more detail above. Once a determination is made as to whether the outcome of the game is associated with the winning of a prize, this outcome can be displayed through the player tracking unit 120 and/or generally on the gaming machine 112. If a prize is not won, the process allows additional wagering and play if desired. As described above in the discussion of FIG. 2, game play and receipt of a wager at 202 can be omitted in some embodiments, such as when a player wishes to redeem accumulated credits from previous game play at a later time.

In the present embodiment, if a specific prize has been won or if credits have been accumulated by a player, player tracking unit 120 can provide an option for the player to redeem the prize and/or credits. See 204. For instance, as described above with regard to FIG. 7, a general redemption button 702 can be displayed once any prizes or credits have been accumulated.

Once an indication that the player wishes to redeem credits or prizes is detected by player tracking unit 120, such as when the player selects a redeem button 702 (FIG. 7), then at 400 a prize fulfillment site 134 is selected based on any number of factors, depending on the application. For instance, the prize fulfillment site 134 can be selected at random, based on past prize winnings or selections, based on player input, based on the type of win, based on player information stored in a player tracking account or entered by the player, based on the type or theming of a game played, and the like.

One implementation in which the selection can be based on previous prize winnings or selections can include providing current offerings that are different than past winnings or selections. For example, if a player has previously won a prize selected from an Internet book seller, the next prize may be fulfilled using an Internet apparel retailer, or the like. When basing the selection on player input, a player can be given the opportunity to select among a plurality of items displayed by fulfillment site 134. Alternatively, the selection can be based on interests, characteristics, and the like, that have been input by the player. In other implementations, selection of the fulfillment entity is based on the type of win. For example, in the context of a slot machine type game, a three-cherry win will result in fulfillment by an Internet movie ticket retailer and a three-plum win will result in fulfillment by an Internet concert ticket retailer. In yet other implementations, selection of the fulfillment entity will be based on information about the player that was stored on a player tracking card, in a player tracking account, on (or accessible to) the fulfillment server 116 or other components of the gaming system, and the like. The information can include data such as the magnitude of the player's last win, the player's gaming history, and the like. According to other implementations, the type of game or theming associated with the game may be used for selecting the fulfillment site. For example, if the player is playing on an Elvis-themed game (e.g. as described in U.S. patent application Ser. No. 09/166,483, filed on Oct. 5, 1998, and incorporated herein by reference), a prize fulfillment site that offers Elvis music and/or memorabilia may be used. Furthermore, if a prize is won on a race car-themed gaming terminal, a prize fulfillment site offering NASCAR memorabilia may be selected.

Once it has been determined which entity or entities will act as the prize fulfillment site 134, then at 402, the prize fulfillment site can be provided with general prize information, such as the value of the prize, the size and/or type of prize awarded, a preselected prize, or the like. In some embodiments, the prize fulfillment site 134 can prearrange with the casino 110 the types of prizes or values of prizes that will be awarded in response to various types of wins. In this manner, the casino may communicate only, for example, the type or value of the prize (or a code associated therewith) and the prize fulfillment site 134 can use this information to retrieve or formulate an appropriate prize or prize selection, corresponding to the value or type of prize won. In some embodiments, the prize fulfillment site 134 can also receive information regarding previous wins or prizes awarded. Using this information, the prize fulfillment site can enhance variety by avoiding offering, as a prize, an item that has already been won by the player. In addition, as described above, the prize fulfillment site 134 can receive information about a player or player characteristics such as preferences, interests, and the like, such that the entity may select an item that is likely to be of interest to a player. For example, the prize fulfillment site 134 may receive information from or about the player based on past user selections, winnings, and the like, that indicates that the player has a preference for a particular genre of book or music. Based on this information, the prize fulfillment site 134 may offer a prize or a selection of prizes corresponding to such interest. In addition, other player information can be used to improve the player's enjoyment of the gaming transaction. For example, player account information can be used to personalize the display. Furthermore, player account information can be used to authenticate a player that wishes to make upgrades, prize changes, and the like.

After general prize information is sent to the prize fulfillment site 134, then at 404, fulfillment server 116 transmits information to a casino financial account 156 (such as a casino bank account) authorizing it to debit the account for the prize amount (which may include not only the value of the goods or services delivered but also the costs of delivery, fee charged by the prize fulfillment site 134, and the like). The charge authorization can be accompanied by an identification number, code, or the like, which can be used for accounting and/or security purposes.

Next, at 406, the player tracking unit 120 can provide a conduit for the player to communicate with the prize fulfillment site 134 by establishing a connection with the prize fulfillment site 134 if one has not already been established. The prize fulfillment site 134, which can be an Internet or other retail establishment, selects or formulates a web page or similar display information showing a prize or selection of prizes to the player via player tracking unit 120. In some embodiments, the web page provided to the player at the gaming terminal is different from a web page provided to retail consumers via the Internet or any other medium that is unaffiliated with the gaming environment, in order to increase the enjoyment of the gaming transaction. If the player is provided with several prizes from which to choose, the player selects the desired prize and/or or indicates options such as color, size, flavor, and the like, using input devices associated with player tracking unit 120. Delivery information is then either input by the user (as described above with regard to FIG. 3) or obtained from a player account, player tracking account, stored information, or the like, as described above. This delivery information is then communicated to the prize fulfillment site 134.

At 404, prize fulfillment site 134 sends a request for transfer of funds from the casino financial account 156. This request can be accompanied by a transaction identifier, which identifies the prize awarded and authorized by the casino at 404. The casino financial account 156 can try to match the request and/or identifier with the authorization received from the casino and, if there is an appropriate match, the casino financial account 156 can transfer the appropriate funds to the prize fulfillment site 134. Although the present embodiment provides a system in which fund transfers are performed on a win-by-win or prize-by-prize basis, it is also possible to perform accounting or balancing between the casino and the prize fulfillment site 134 periodically. For instance, numerous prize transactions can be accumulated and accounting can be performed in a batch process (e.g. hourly, daily and the like).

Once the fulfillment information and any other necessary information is provided to the prize fulfillment site, then at 406, a receipt can be issued to the player. For instance, a ticket printer can dispense a printout of the fulfillment information displayed on the player tracking unit 120 once the transaction is complete. As described with regard to FIG. 2, it is also possible to send multiple gaming transactions to a prize fulfillment site at a later time. In these embodiments, a receipt can be provided to the player once the fulfillment information is provided to the fulfillment server 116. The prize fulfillment site 134 then delivers the one or more prizes to the player according to any prize fulfillment information provided by the player to the prize fulfillment site. At 408, if the player was previously playing a game, the player can be given an option to continue playing the game. If the player chooses to continue, game play can proceed at 202. Otherwise, the gaming session can end at 410.

One feature that can be added to any of the exemplary embodiments described above includes displaying advertisements for the one or more prize fulfillment sites 134 offering prizes through the player tracking unit 120 or gaming machine 112 generally. For instance, during game play, advertisements such as “banner ads” or “pop up ads” can be displayed on the player tracking unit 120. One or more advertisements can be displayed at a time, and can also feature an option to browse the prize fulfillment site's offerings, thereby providing an incentive for a player to continue game play in order to earn particular prizes. Accordingly, the advertisements can be passive or active, depending on the application. Passive advertisements can present displays to the player without any input from the player. Active advertisements can receive input from a player and provide a catalog of prizes, descriptions of prizes, and the like.

Although the exemplary embodiments described above with regard to the process flow diagrams shown in FIGS. 2-4 depict particular items such as providing a receipt to a player, providing an option to upgrade, and the like, it should be recognized that various items can be modified, rearranged, or removed without departing from the present invention. For instance, in some embodiments, a receipt may not be provided to a player after the prize fulfillment site 134 receives a fulfillment request. Additionally, in various embodiments, a gaming system can determine that a player is entitled to a prize at various points in a prize redemption process. For example, some points at which a player can be deemed entitled to a prize include before the gaming system receives instructions that the player wishes to redeem a prize, once it is determined that a selected prize has a value that does not exceed the player's accumulated credits, once the player expresses a desire to redeem a prize, and the like.

It should be recognized that various items can also be combined within the scope of the present invention. For instance, in FIG. 4, items 402 (send general prize information to selected prize fulfillment site) and 404 (authorize debit of casino financial account) can be combined without departing from the scope of the present invention. In addition, although player tracking devices and player tracking units are described as providing an interface between a player and the prize fulfillment sites 134, it should be recognized that other intermediate devices can be used in place of player tracking devices and player tracking units, within the scope of the present invention.

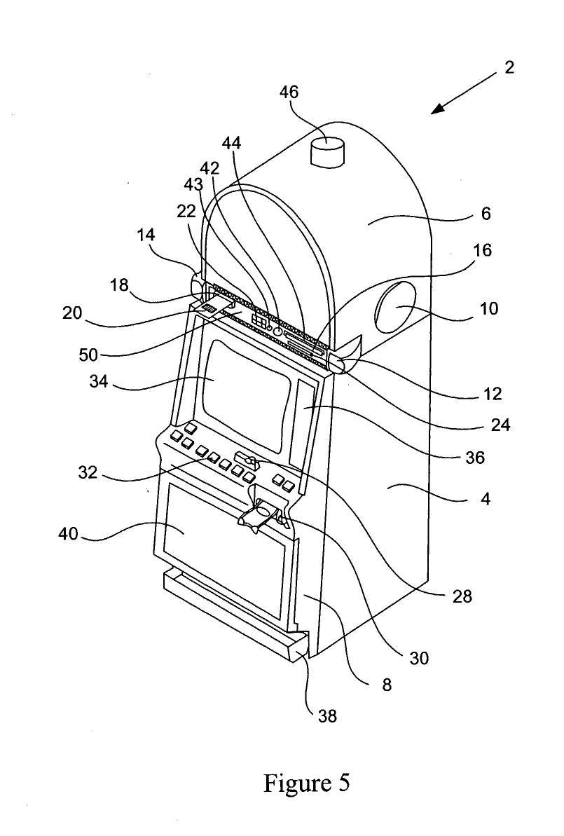

Turning to FIG. 5, a video gaming machine 2 that can be used with the present invention is shown. Machine 2 includes a main cabinet 4, which generally surrounds the machine interior (not shown) and is viewable by users. The main cabinet includes a main door 8 on the front of the machine, which opens to provide access to the interior of the machine. Attached to the main door are player-input switches or buttons 32, a coin acceptor 28, a bill validator 30, a coin tray 38, and a belly glass 40. Viewable through the main door is a video display monitor 34 and an information panel 36. The display monitor 34 will typically be a cathode ray tube, high resolution flat-panel LCD, or other conventional electronically controlled video monitor. The information panel 36 may be a back-lit, silk screened glass panel with lettering to indicate general game information including, for example, the number of coins played. The bill validator 30, player-input switches 32, video display monitor 34, and information panel are devices used to play a game on the game machine 2. The devices are controlled by circuitry housed inside the main cabinet 4 of the machine 2. Furthermore, a master gaming controller housed within main cabinet 4 can control games of chance played on the gaming machine 2 and can control the outcomes of games played. Many possible games, including traditional slot games, video slot games, video poker, video black jack, video keno, video pachinko, lottery games and other games of chance as well as bonus games may be provided with gaming machines used with this invention. As described above with regard to FIG. 1, although a master gaming controller can be included in gaming machine 2, it should be recognized that gaming machine 2 can act as a client in some applications and an external computer, server, or the like, can present one or more games of chance to the gaming machine 2. In these applications, gaming machine 2 may not include a master gaming controller.

The gaming machine 2 includes a top box 6, which sits on top of the main cabinet 4. The top box 6 houses a number of devices, which may be used to add features to a game being played on the gaming machine 2, including speakers 10, 12, 14, a ticket printer 18 which may print bar-coded tickets 20 used as cashless instruments, and the like. The player tracking unit 50 located at the base of top box 6 includes a key pad 22 for entering player tracking information, a florescent display 16 for displaying player tracking information, a card reader 24 for entering a magnetic striped card containing player tracking information, a microphone 43 for inputting voice data, a speaker 42 for projecting sounds, and a light panel 44 for displaying various light patterns used to convey gaming information. Other devices can also be included in player tracking unit 50 such as a touch screen, a lighted bezel around the card reader 24, a lighted bezel around the touch screen, and the like. A player playing a game on the gaming machine 2 or a person near the gaming machine may view the light patterns from the light panel 216. In other embodiments, the player tracking unit and associated player tracking interface devices, such as 16, 22, 24, 42, 43 and 44, may be mounted within the main cabinet 4 of the gaming machine, on top of the gaming machine, or on the side of the main cabinet of the gaming machine.

Understand that gaming machine 2 is but one example from a wide range of gaming machine designs that can be used with the present invention. For example, not all suitable gaming machines have top boxes. Further, some gaming machines have two or more game displays—mechanical and/or video. And, some gaming machines are designed for bar tables and have displays that face upwards. Still further, some machines may be designed entirely for cashless systems. Such machines may not include such features as bill validators, coin acceptors and coin trays. Instead, they may have only ticket readers, card readers and ticket dispensers. Those of skill in the art will understand that the present invention, as described below, can be deployed on most any gaming machine now available or hereafter developed.

Returning to the example of FIG. 5, when a user wishes to play the gaming machine 2, he or she inserts cash through a wager input device such as the coin acceptor 28 or bill validator 30. Other types of wager input devices include credit accounts, debit accounts, and the like. In addition, the player may use a cashless instrument of some type to register credits on the gaming machine 2. For example, the bill validator 30 may accept a printed ticket voucher, including 20, as an indicia of credit. As another example, the card reader 24 may accept a debit card or a smart card containing cash or credit information that may be used to register credits on the gaming machine.

Prior to beginning a game play session on the gaming machine 2, a player may insert a player tracking card into the card reader 24 to initiate a player tracking session, as described above with regard to FIG. 2. However, as described above with regard to FIG. 3, inserting a player tracking card may be unnecessary in some applications where a player does not wish to provide player information to the casino. If a player tracking card is used, then after insertion of a card, the player may be visually prompted on the display screen 16 or aurally prompted using the speaker to enter identification information such as a PIN code using the key pad 22. Typically, the player tracking card may remain in the card reader 24 during the game play session. As another example, the gaming machine may transfer player tracking information from a portable wireless device worn by the player via a wireless interface device (not shown) on the gaming machine 2. An advantage of using a portable wireless device is that the transfer of player tracking information is automatic and the player does not have to remember to correctly insert a player tracking card into the gaming machine.

During a player tracking session on the gaming machine, features of the player's game play during a game play session on the gaming machine, such as an amount wagered during the game play session, may be converted to credits and stored in the player's player tracking account on a player tracking server. Later, accumulated credits may be redeemed for prizes, currency, “comps” such as free meals or free rooms, and the like, as described above. Usually, the player tracking card inserted into the card reader contains at least player tracking account information. When the card is inserted correctly into the card reader 24, the information stored on the card, such as the player's account information, may be read by the card reader and transferred by a logic device on the player tracking unit to the player tracking server 126. The player tracking account information allows the player tracking server 126 to store credits accumulated during the game play session to the appropriate account. When player tracking information is not provided by the player, for instance, when the player tracking card has been inserted incorrectly into the card reader 24, credits are not accumulated.

During the course of a game, a player may be required to make a number of decisions, which affect the outcome of the game. For example, a player may vary his or her wager on a particular game, select a prize for a particular game, or make game decisions that affect the outcome of a particular game. The player may make these choices using the player-input switches 32, the video display screen 34 or using some other device which enables a player to input information into the gaming machine. Certain player choices may be captured by player tracking software loaded in a memory inside of the gaming machine. For example, the rate at which a player plays a game or the amount a player bets on each game may be captured by the player tracking software.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects include flashing lights, strobing lights or other patterns displayed from lights on the gaming machine 2, from lights behind the belly glass 40 or the light panel on the player tracking unit 44.

After the player has completed a game and received a prize, as described above, the player may receive a receipt, have an option to continue game play, and/or end the gaming session. In other embodiments, the player may receive game tokens from the coin tray 38 or the ticket 20 from the printer 18, which may be used for further games or to redeem a prize at a later time. Further, the player may receive a ticket 20 for food, merchandise, or games from the printer 18. The type of ticket 20 may be related to past game playing recorded by the player tracking software within the gaming machine 2. In some embodiments, these tickets may be used by a game player to obtain game services. In addition, when the player has inserted a player tracking card in the card reader to initiate a player tracking session, to prevent the player from leaving or “abandoning” their card in the card reader 24, a voice message, such as “please remove your card,” may be projected from the sound projection device 44.

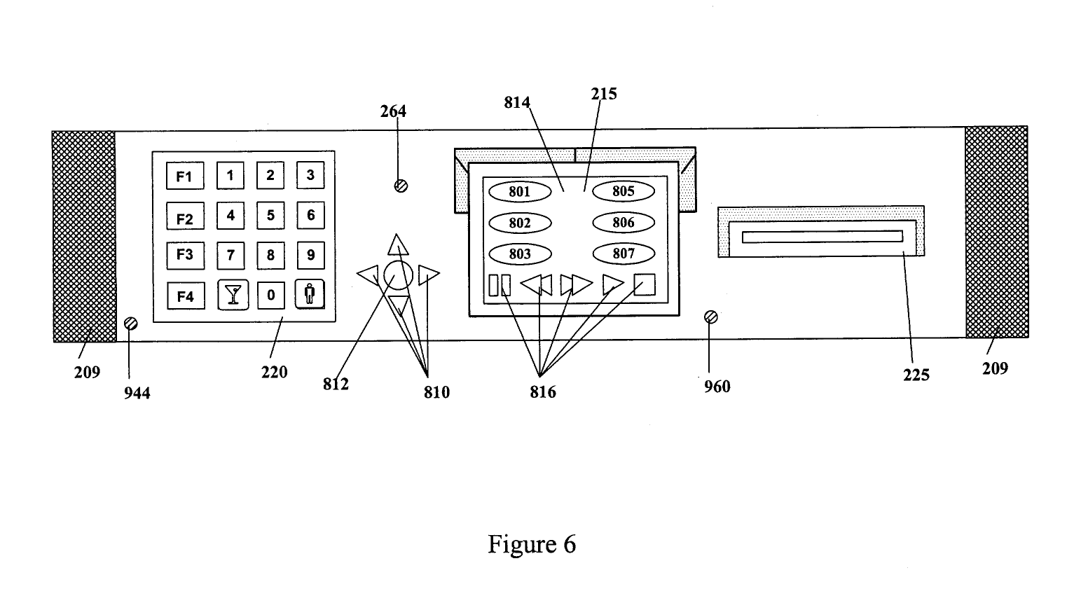

FIG. 6 is a block diagram of a user interface for one embodiment of a player tracking unit 200 that can be used with various embodiments of the present invention. In one embodiment, the display may be used to display a number of menu items, 801, 802, 803, 805, 806 and 807. The menu items may represent entertainment content sources that may be displayed on the player tracking unit, such as menu items for video on demand, or the menu items may represent a table of contents, such as different entertainment content categories, that may lead to detailed menus for each category selected. Furthermore, the menu items can represent advertisements from different prize fulfillment sites 134, different prizes available from one or more prize fulfillment sites, and the like. In some embodiments, the casino or other gaming machine provider can receive a payment from a prize fulfillment site 134 each time a player selects the prize fulfillment site's advertisement, logo, or the like, for further viewing or information, or when a player selects a prize from a particular prize fulfillment site 134. Furthermore, these menu items can be prizes selectable by a player according to various embodiments, as described above. Therefore, with the present invention, menus may be nested in different layers. Details of other types of menu interfaces that may be used with the present invention are described in co-pending U.S. application Ser. No. 09/961,051, filed on Sep. 20, 2001, and entitled “GAME SERVICE INTERFACES FOR PLAYER TRACKING TOUCH SCREEN DISPLAY,” which is incorporated herein in its entirety and for all purposes.

The menu items may be selected using a number of different input mechanisms. In one embodiment, the display 215 may include a touch screen 814 that may be used to detect a selection of a menu item. In another embodiment, the menu items may be selected using input buttons 810 and enter button 812. In yet another embodiment, the key pad 220 may be used to menu items or change channels on the display.

As described above, when a game player wants to play a game on a gaming machine and utilize the player tracking services available through the player tracking unit, a game player inserts a player tracking card, such as a magnetic striped card, into the card reader 24. For current player tracking programs, the most common approach for providing identification information is to issue a magnetic-striped card storing the necessary identification information to each player that wishes to participate in a given player tracking program. Typically, the player tracking server 126 stores player tracking account records including the number of player tracking points previously accumulated by the player. This information can be accessible to fulfillment server 116. While a player tracking card is inserted in the card reader 24, the player tracking server 120 may use the game play information provided by the player tracking unit 107 to generate credits and add the credits to a player tracking account identified by the player tracking card. The credits generated by the player tracking server 120 are stored in a memory of some type on the player tracking server.

As suggested above, a player's incentive for using the player tracking services is receiving awards provided by the gaming machine operator (e.g., the casino). Some incentives for a casino to provide player tracking services are to generate “brand” loyalty, gather valuable information that may be used for marketing, and provide better customer services.

Player tracking cards and player tracking programs are becoming more and more popular. They have become a de facto marketing method of doing business at casinos. The programs allow a casino to identify and reward customers based upon their previous game play history. In particular, a goal of the casinos is to identify and then to provide a higher level of service to certain groups of players identified as especially valuable to the casinos. For instance, players that visit the casino, on average, once a week may be deemed as “special” customers and the casino may desire to cultivate a “special” relationship with these customers. Furthermore, as described above in conjunction with various embodiments of the present invention, even if a player does not wish to participate in player tracking programs, a player tracking unit can provide an interface between the player and a prize fulfillment entity 134.

For a more detailed discussion of player tracking units, see U.S. patent application Ser. No. 09/921,489, entitled “PLAYER TRACKING COMMUNICATION MECHANISMS IN A GAMING MACHINE” by Hedrick et al., filed on Aug. 2, 2001, and U.S. patent application Ser. No. 10/246,373, entitled “PLAYER TRACKING COMMUNICATION MECHANISMS IN A GAMING MACHINE” by Hedrick et al., filed on Sep. 16, 2002.

In light of the above description, a number of benefits associated with various embodiments of the present invention can be seen. In particular, various embodiments of the present invention facilitate electronic fulfillment of prizes, especially non-monetary prizes and reduce or eliminate the burden on casinos and other gaming establishments arising from activities associated with prize fulfillment such as the cost of maintaining inventory, delivering goods or services, accounting or tracking processes, and the like. Additionally, for a gaming machine 112 displaying advertisements for the one or more prize fulfillment sites 134 offering prizes through player tracking unit 120 or gaming machine 112 generally, the casino or other gaming establishment can collect advertising fees from these sites, thereby further reducing the cost of providing non-monetary prizes. Furthermore, various embodiments of the present invention facilitate the provision of a relatively wide variety of non-monetary prizes, which can help maintain player interest. In addition, by using player tracking unit 120 as an interface for providing prize redemption and fulfillment, legacy machines retrofitted with player tracking units 120 can participate in non-monetary prize programs. Retrofitting these legacy machines in this manner can save casinos and other gaming establishments the time and expense of either replacing legacy machines or realizing potentially less profitability from these machines if they fail to provide enough incentive for players to continue playing them.

### CONCLUSION

Although the above generally describes the present invention according to specific exemplary processes and apparatus, various modifications can be made without departing from the spirit and/or scope of the present invention. Therefore, the present invention should not be construed as being limited to the specific forms shown in the appended figures and described above.

What is claimed is:

1. A method of fulfilling prizes won during game play on a gaming machine, the method comprising:
(a) determining that a player is entitled to a prize for a result achieved while playing a game on the gaming machine;
(b) presenting prize fulfillment options to the player via a player tracking device;
(c) receiving prize fulfillment specifications entered by the player in response to the presented prize fulfillment options; and
(d) communicating the player's prize fulfillment specifications to a prize fulfillment site that is responsible for fulfilling prizes and is remote from said property.

2. The method of claim 1, wherein receiving the prize fulfillment specifications comprises receiving said specifications from the player tracking device, through which the player enters said specifications.

3. The method of claim 1, wherein receiving prize fulfillment specifications entered by the player includes receiving prize fulfillment specifications from a player tracking account or card associated with the player that includes information entered by the player at a previous time.

4. The method of claim 3, wherein presenting prize fulfillment options to the player is transparent to the player when prize fulfillment specifications are provided by a player tracking account or card associated with the player.

5. The method of claim 4, wherein presenting prize fulfillment options and receiving prize fulfillment specifications are performed as part of a quick redemption of the prize.

6. The method of claim 1, wherein communicating the player's prize fulfillment specifications to the prize fulfillment site comprises communicating said specifications from the player tracking device.

7. The method of claim 1, wherein the prize fulfillment specifications include a preferred delivery site and a selection of delivery options.

8. The method of claim 1, further comprising receiving instructions from the player to redeem accumulated credits for the prize.

9. The method of claim 8, wherein receiving instructions from the player to redeem accumulated credits for the prize is performed prior to (a).

10. The method of claim 8, wherein the prize fulfillment specifications entered by the player include a selected prize having a prize value associated with it, and further comprising determining if the prize value exceeds the accumulated credits.

11. The method of claim 10, further comprising providing an option to upgrade if the prize value exceeds the accumulated credits.

12. The method of claim 11, further comprising receiving credits from the player, wherein the credits can be used to upgrade to a prize selected by the player.

13. The method of claim 12, wherein the credits are currency.

14. The method of claim 12, wherein the credits are obtained by debiting an account.

15. The method of claim 12, wherein the credits are obtained by applying a charge to a credit account.

16. The method of claim 12, wherein the credits are obtained from a cashless ticket or other player card.

17. The method of claim 11, wherein the option to upgrade includes allowing the player to pay an amount equivalent to the difference between the prize value and the accumulated credits.

18. The method of claim 10, further comprising authorizing the remote prize fulfillment site to fulfill the player's prize fulfillment specifications.

19. The method of claim 1, wherein the prize is preselected by the player before the prize is redeemable to the player.

20. The method of claim 19, further comprising notifying the player when the preselected prize is redeemable.

21. The method of claim 1, wherein presenting prize fulfillment options to the player comprises presenting the player with a choice of prizes by presenting information about individual prize choices.

22. The method of claim 21, further comprising providing an option to upgrade if the player wishes to select a prize having a prize value that exceeds an amount redeemable to the player.

23. The method of claim 1, further comprising providing a receipt to the player, wherein the receipt includes information about the prize fulfillment specifications entered by the player.

24. The method of claim 1, wherein the player's prize fulfillment specifications are communicated to a prize fulfillment site according to a predetermined schedule.

25. The method of claim 24, wherein when the player's prize fulfillment specifications are communicated to the prize fulfillment site, one or more other prize fulfillment specifications for one or more players are communicated to the prize fulfillment site.

26. A gaming machine apparatus comprising:
(a) a master gaming controller configured to control the outcomes of games played on the gaming machine, wherein prizes may be awarded for the outcomes;
(b) a player tracking device comprising (i) a video display screen; (ii) logic for providing a prize fulfillment player interface through the display screen; and (iii) logic for providing a prize selection player interface through the display screen; and
(c) a network interface configured to communicate prize selection and prize fulfillment to one or remote prize fulfillment sites that are responsible for fulfilling the prizes.

27. The gaming machine of claim 1, wherein the player tracking device further comprises logic for providing a prize redemption player interface through the display screen.

28. The gaming machine of claim 27, wherein the prize redemption player interface allows a player to initiate redeeming accumulated credits for a prize.

29. The gaming machine of claim 26, wherein the prize fulfillment player interface allows a player to specify a preferred delivery site and a selection of delivery options for an awarded prize.

30. The gaming machine of claim 26, wherein the prize fulfillment player interface allows a player to specify player information for an awarded prize.

31. The gaming machine of claim 26, wherein the prize selection player interface allows a player to select a prize from a plurality of available prizes.

32. The gaming machine of claim 31, wherein the prize selection player interface allows a player to select an option to upgrade if a prize selected by the player has a prize value that exceeds an amount redeemable by the player.

33. The gaming machine of claim 32, wherein the option to upgrade includes allowing the player to pay an amount equivalent to the difference between the prize value and the amount redeemable by the player.

34. The gaming machine of claim 33, further comprising a wager input device configured to receive credits from a player, wherein the credits can be used to upgrade to a prize selected by the player.

35. The gaming machine of claim 34, wherein the wager input device is configured to accept currency as credits, to facilitate debiting an account to obtain credits, to facilitate charging a credit account to obtain credits, to accept a cashless ticket as credits, or to accept credits from a smartcard or other player card.

36. The gaming machine of claim 26, further comprising a ticket printer configured to provide a receipt that includes information about prize fulfillment specifications entered by a player.

37. The gaming machine of claim 26, wherein the network interface is configured to communicate a plurality of prize fulfillment specifications to one or more prize fulfillment sites periodically.

38. The gaming machine of claim 26, wherein the video display screen is configured to display an advertisement for a remote prize fulfillment site that offers at least one available prize through the player tracking device.

39. The gaming machine of claim 38, wherein the advertisement is a banner ad or a pop up ad.

40. A gaming machine apparatus comprising:
a player tracking device comprising a video display screen, logic for providing a prize fulfillment player interface through the display screen and logic for providing a prize selection player interface through the display screen; and
a network interface configured to communicate prize selection and prize fulfillment to one or remote prize fulfillment sites that are responsible for fulfilling prizes.

41. The gaming machine of claim 40, further comprising a wager input device configured to receive credits from a player, wherein the credits can be used to upgrade to a prize selected by the player.

42. The gaming machine of claim 40, further comprising a ticket printer configured to provide a receipt that includes information about prize fulfillment specifications entered by a player.

43. A computer program product including computer code for fulfilling prizes won during game play on a gaming machine, the computer program product comprising:
(a) computer code for determining that a player is entitled to a prize for a result achieved while playing a game on the gaming machine;
(b) computer code for presenting prize fulfillment options to the player via a player tracking device;
(c) computer code for receiving prize fulfillment specifications entered by the player in response to the presented prize fulfillment options; and
(d) computer code for communicating the player's prize fulfillment specifications to a prize fulfillment site that is responsible for fulfilling prizes and is remote from said property.

44. The computer program product of claim 43, wherein the computer code for receiving the prize fulfillment specifications comprises computer code for receiving said specifications from the player tracking device, through which the player enters said specifications.

45. The computer program product of claim 43, wherein the computer code for receiving prize fulfillment specifications entered by the player includes computer code for receiving prize fulfillment specifications from a player tracking account or card associated with the player that includes information entered by the player at a previous time.

46. The computer program product of claim 45, wherein the prize fulfillment options are transparent to the player when prize fulfillment specifications are provided by a player tracking account or card associated with the player.

47. The computer program product of claim 46, wherein presenting prize fulfillment options and receiving prize fulfillment specifications are performed as part of a quick redemption of the prize.

48. The computer program product of claim 43, wherein the computer code for communicating the player's prize fulfillment specifications to the prize fulfillment site comprises computer code for communicating said specifications from the player tracking device.

49. The computer program product of claim 43, wherein the prize fulfillment specifications include a preferred delivery site and a selection of delivery options.

50. The computer program product of claim 43, further comprising computer code for receiving instructions from the player to redeem accumulated credits for the prize.

51. The computer program product of claim 50, wherein the prize fulfillment specifications entered by the player include a selected prize having a prize value associated with it, and further comprising computer code for determining if the prize value exceeds the accumulated credits.

52. The computer program product of claim 51, further comprising computer code for providing an option to upgrade if the prize value exceeds the accumulated credits.

53. The computer program product of claim 52, further comprising computer code for receiving credits from the player, wherein the credits can be used to upgrade to a prize selected by the player.

54. The computer program product of claim 53, wherein the credits are currency.

55. The computer program product of claim 53, wherein the credits are obtained by debiting an account.

56. The computer program product of claim 53, wherein the credits are obtained by applying a charge to a credit account.

57. The computer program product of claim 53, wherein the credits are obtained from a cashless ticket or other player card.

58. The computer program product of claim 52, wherein the option to upgrade includes allowing the player to pay an amount equivalent to the difference between the prize value and the accumulated credits.

59. The computer program product of claim 51, further comprising computer code for authorizing the remote prize fulfillment site to fulfill the player's prize fulfillment specifications.

60. The computer program product of claim 43, wherein the prize is preselected by the player before the prize is redeemable to the player.

61. The computer program product of claim 60, further comprising computer code for notifying the player when the preselected prize is redeemable.

62. The computer program product of claim 43, wherein presenting prize fulfillment options to the player comprises presenting the player with a choice of prizes by presenting information about individual prize choices.

63. The computer program product of claim 62, further comprising computer code for providing an option to upgrade if the player wishes to select a prize having a prize value that exceeds an amount redeemable to the player.

64. The computer program product of claim 43, further comprising computer code for providing a receipt to the player, wherein the receipt includes information about the prize fulfillment specifications entered by the player.

65. The computer program product of claim 43, wherein the computer code for communicating the player's prize fulfillment specifications to a prize fulfillment site includes computer code for communicating the player's prize fulfillment specifications to a prize fulfillment site according to a predetermined schedule.

66. The computer program product of claim 65, wherein the computer code for communicating the player's prize fulfillment specifications to a prize fulfillment site according to a predetermined schedule is further configured to communicate one or more other prize fulfillment specifications for one or more players to the prize fulfillment site when communicating the player's prize fulfillment specifications to the prize fulfillment site.
